(19) United States
(12) Patent Application Publication
(10) Pub. No.: US 2003/0000919 A1
(43) Pub. Date: Jan. 2, 2003

(54) Formation of a smooth surface on an optical component

(76) Inventor: James R. Velebir JR., Laguna Niguel, CA (US)

Correspondence Address: Travis Dodd, 2490 Heyneman Hollow, Fallbrook, CA, 92028, US

(21) Appl. No.: 09/896,127

(22) Filed: Jun. 29, 2001

(51) Int. Cl. G02B 6/12

(52) U.S. Cl. 216/24; 216/99; 134/1.1; 134/2; 134/3

(57) ABSTRACT

A method for smoothing one or more surfaces on an optical component is disclosed. The method includes obtaining an optical component having one or more surfaces and performing a wet etch so as to smooth the one or more surfaces.

### RELATED APPLICATIONS

This application is related to U.S. patent application Ser. No. 09/724,177; entitled “Formation of a Smooth Surface on an Optical Component”; filed on Nov. 28, 2000 and incorporated herein in its entirety.

### BACKGROUND

1. Field of the Invention

The invention relates to one or more optical networking components. In particular, the invention relates to methods of smoothing one or more surfaces on optical networking components.

2. Background of the Invention

A variety of the components used in optical networking include one or more surfaces that reflect or transmit light. The smoothness of these surfaces can affect the performance of the optical component and/or the optical network. For instance, many optical components include a facet through which light signals enter or exit the optical component. The amount of reflection and scattering that occurs at the facet increases as the roughness of the facet increases. As a result, increasing the roughness of the surface increases the amount of optical loss associated with the optical component.

For the above reasons, there is a need for a method of smoothing surfaces on optical components.

### SUMMARY OF THE INVENTION

The invention relates to a method for smoothing one or more surfaces on an optical component. The method includes obtaining an optical component having one or more surfaces and performing a wet etch so as to smooth the one or more surfaces.

Another embodiment of the method includes applying a first medium to the one or more surfaces of the optical component so as to convert a material that defines the one or more surfaces of the optical component to a second material. In some instances, the material is isotropically converted. The method also includes applying a second medium to the one or more surfaces of the optical component so as to remove at least a portion of the second material from the one or more surfaces of the optical component. The second medium is applied concurrently with the first medium.

In some instances, the first medium is an oxidant that forms an oxide of the material and the second medium is an oxide remover that removes the oxide from the material.

Yet another embodiment of the method includes obtaining an optical component having a material defining one or more surfaces. The method also includes applying an oxidant to the one or more surfaces such that an oxide of the material is formed on the one or more surfaces. In some instances, the oxide is isotropically formed on the one or more surfaces. The method further includes applying an oxide remover to the one or more surfaces so as to remove the oxide from the one or more surfaces. The oxide remover is applied to the one or more surfaces concurrently with the oxidant.

The one or more surfaces can be the surfaces of a light transmitting medium configured to carry light signals. The one or more surfaces can be surfaces through which the light signals are transmitted or surfaces at which light signals are reflected.

The oxidant and the oxide remover can be included in a solvent. The solvent can include acetic acid. The solvent can exclude water. In some instances the oxidant includes HNO₃ and the oxide remover includes HF. The molar ratio of oxidant to oxide remover can fall within a range of 1:1 to 1:20 or 1:4 to 1:8.

In some embodiments of the method, one or more foreign substance removal operations are performed before smoothing the one or more surfaces of the optical component. The foreign substance removal operations are configured to remove foreign substances from the one or more surfaces to be smoothed by the smoothing etch. Examples of foreign substance removal operations include an oxygen plasma clean, a polymer residue clean and silica removal.

### BRIEF DESCRIPTION OF THE FIGURES

FIG. 1A illustrates a portion of a component having a plurality of light signal reflecting surfaces and a light signal transmission surface.

FIG. 1B illustrates a portion of a component having a light signal reflecting surface positioned at the intersection of two waveguides.

FIG. 2A through FIG. 2D illustrate a method of forming an optical component having a surface to be smoothed.

### DETAILED DESCRIPTION OF THE PREFERRED EMBODIMENT

The invention relates to a method of smoothing one or more surfaces on an optical component. The method includes providing an optical component having one or more surfaces that have an undesirable level of roughness. The surfaces can be surfaces where light signals are reflected or transmitted. The method also includes performing a smoothing etch so as to smooth the one or more surfaces. In some instances, the component is cleaned before the smoothing etch is performed.

A suitable smoothing etch includes concurrently applying a first medium and a second medium to the one or more surfaces. The first medium is selected to convert the material that defines the one or more surfaces to a second material. For instance, the first medium can be an oxidant selected to convert the material that defines the one or more surfaces to an oxide of the material that defines the one or more surfaces. In some instances, the first medium isotropically converts the material. The second medium is selected to remove the second material from the one or more surfaces. For instance, the second medium can be selected to remove the oxide from the one or more surfaces.

The roughness of the one or more surfaces results from the presence of bumps on the one or more surfaces. The first medium can be selected to convert the material at the tops of bumps to the second material faster than it converts the material in the valleys between the bumps to the second material. As a result, the second medium removes material from the tops and sides of the bumps faster than the second medium removes materials from between the bumps. Removing material from the tops of the bumps faster than from between the bumps causes the bumps to be smoothed.

The first medium and the second medium can be applied to the one or more surfaces in a wet etch. A suitable wet etch solution employs HNO₃ as the first medium and HF as the second medium. When silicon defines the one or more surfaces, this wet etch solution can be used at room temperature and pressure to provide the one or more surfaces with a roughness less than 1 nm depending on the duration, original roughness of the one or more surfaces and conditions of the smoothing etch. The ability to perform the smoothing etch at room temperature and pressure reduces the costs and complexity associated with fabrication of the optical components.

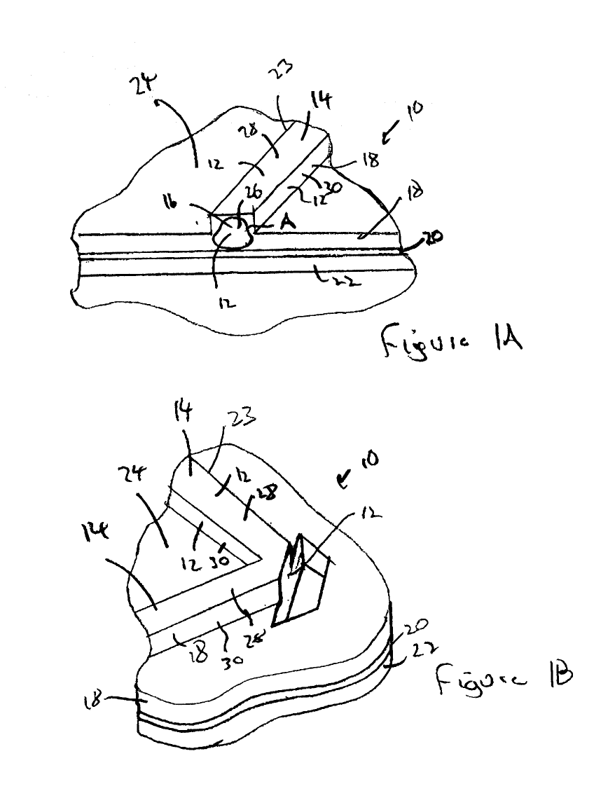

FIG. 1A illustrates an edge of a component 10 having a waveguide 14 ending in a light transmitting surface 12 known as a facet 16. The component 10 includes a light transmitting medium 18 positioned adjacent to a light barrier 20. The light barrier 20 is positioned adjacent to a substrate 22. The light transmitting medium 18 is formed into a ridge 23 extending from a side 24 of the component 10. The ridge 23 defines a portion of a light signal carrying region 26. The light barrier 20 includes a material that encourages light traveling through the light signal carrying region 26 to be reflected back into the light signal carrying region 26. Accordingly, the light barrier 20 defines another portion of the light signal carrying region 26. A profile of a light signal traveling along the light signal carrying region 26 is illustrated by the arrow labeled A.

Suitable substrates 22 include, but are not limited to, silicon. Suitable light transmitting media include, but are not limited to, silicon and polysilicon. The light barrier 20 can include a material having reflective properties such as metals. Alternatively, the light barrier 20 can have a different index of refraction than the light transmitting medium 18. For instance, the light barrier 20 can be silica or air when the light transmitting medium 18 is silicon. The change in the index of refraction causes reflection of a portion of the light signals incident on the light barrier 20.

The component 10 includes a facet 16 through which light signals enter and/or exit the component 10. The facet 16 is often connected to an optical fiber in communication with an optical network. Light signals from the network can enter the optical component 10 through the facet 16 and/or light signals from the component 10 can exit the component 10 through the facet 16. The rougher the surface 12, the larger the amount of reflection and scattering that will occur at the facet 16. Accordingly, a rough facet 16 can be associated with increased optical loss.

The ridge 23 includes a top side 28 between two lateral sides 30. The light signals are reflected off these sides 28, 30 as the light signal travels along the light signal carrying region 26. The amount of reflection and scattering that occurs as the light signal travels along the waveguide 14 increases as the roughness of these sides 28, 30 increases. Accordingly, rough sides can increase the optical losses associated with the waveguide 14.

FIG. 1B illustrates a portion of an optical component 10 having another embodiment of a reflecting surface 12. The reflecting surface 12 is positioned at the intersection of two waveguides 14. The surface 12 can be positioned at an angle that reflects light from one of the waveguides 14 into the other waveguide 14. For instance, the surface 12 can be positioned so as to provide total internal reflection. Total internal reflection is encouraged by increasing the angle between the intersecting waveguides 14. The surface 12 can extend through the light transmitting medium 18 to the light barrier 20. As shown in FIG. 1A, the light signals travel through the light transmitting medium 18 in the ridge 23 and below the ridge 23. Accordingly, extending the surface 12 through the light transmitting medium 18 increases the percentage of the light signal that is reflected by the surface 12. As noted above, roughness increases the amount of scattering and reflection at the surface 12. Accordingly, smoothing this surface 12 can increase the performance of the component 10.

The components 10 and waveguides 14 illustrated in FIG. 1A and FIG. 1B are only an example of the types and forms of components 10 that can be employed in conjunction with the present invention. For instance, U.S. patent application Ser. No. 09/686,733; entitled “Waveguide Having a Light Drain”; filed on Oct. 10, 2000 and U.S. patent application Ser. No. 60/239,534; entitled “A Compact Integrated Optics Based Arrayed Waveguide Demultiplexer”; filed on Oct. 10, 2000 teach a variety of different component 10 constructions and are each incorporated herein in their entirety.

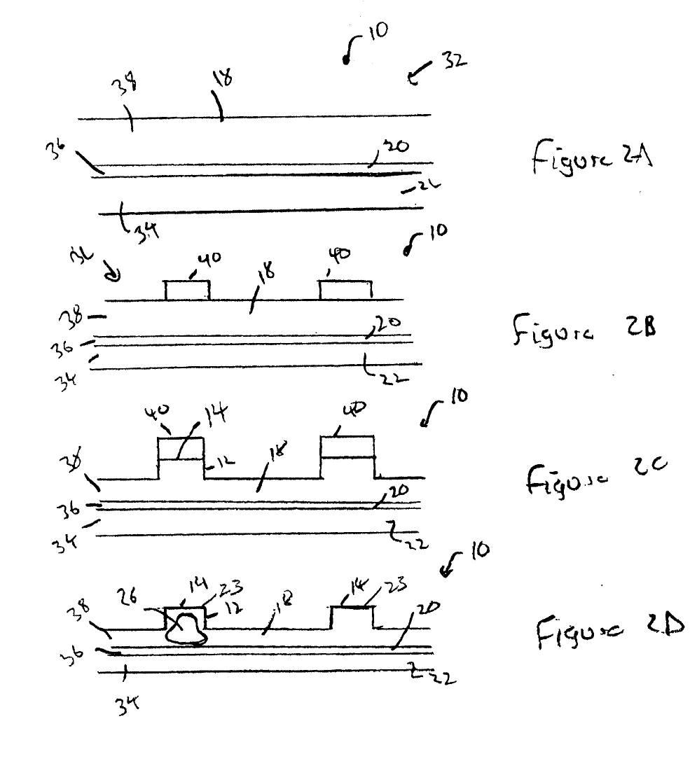

FIGS. 2A through FIG. 2D illustrate one method that can be used to form optical components 10 illustrated in FIG. 1A and/or FIG. 1B. FIG. 2A illustrates an example of a silicon on insulator wafer 32. The silicon on insulator wafer 32 includes a first silicon layer 34, a silica layer 36 and a second silicon layer 38. A mask 40 is formed over the regions of the second silicon layer 38 where the ridges 22 are to be formed as shown in FIG. 2B. A surface formation etch is performed so as to etch the exposed regions of the second silicon layer 38. The surface formation etch results in formation of the lateral sides 30 of the ridge 23 as shown in FIG. 2C. Accordingly, the surface formation etch is performed until the lateral sides 30 the ridge 23 have the desired height as shown in FIG. 2C. The ridge 23 typically extends about 1-9 μm above the side 24 of the component 10.

In the case of constant 1×mask printing, the sides of the mask 40 are typically formed, with about 50-100 nm of roughness due to the limitation of mask 40 formation technologies. This roughness of the mask 40 results in a roughness of about 50-100 nm extending along the length of the ridge 23. The smoothness moving along a line extending vertically along the height of the ridge 23 results from the choice of surface formation etch used to form the ridge 23. Because the roughness along the length of the ridge 23 is caused by a different mechanism than the roughness along the height of the ridge 23, a different level of roughness can occur in different directions. A smoothing etch according to the present invention can provide smoothing in each of these directions.

After formation of a ridge 23 having the desired height, the mask 40 is removed to provide the component 10 illustrated in FIG. 2D.

Reflecting surfaces 12 such as the reflecting surface 12 illustrated in FIG. 1B are typically formed by employing various combinations of masking 40 and surface formation etches.

The surface formation etch is typically a wet etch or a dry etch that etches the second silicon layer 38 at about 0.5-20 μm/min. Additionally, the surface formation etch is typically an isotropic etch. The surface formation etch is often performed with the Bosch process where application of an etch is alternated with application of a passivant. The Bosch process typically provides a surface 12 with a roughness of greater than 220 nm. In some instances, the Bosch process provides a roughness of greater than 270 nm. In other instances, the Bosch process provides a roughness of greater than 330 nm. U.S. patent application Ser. No. 09/690,959, filed on Oct. 16, 2000 and entitled “Formation of a Smooth Vertical Surface on an Optical Component” teaches a method of forming a surface 12 having a roughness greater than 20 nm and is incorporated herein in its entirety. Another suitable surface formation etch is taught in U.S. patent application Ser. No. 09/845,093, filed on Apr. 27, 2001, entitled “Formation of an Optical Component having Smooth Sidewalls” and incorporated herein in its entirety. Accordingly, surface formation etches can be performed so as to achieve surfaces 12 having a roughness greater than 50 nm, 100 nm, 150 nm, 170 nm or 190 nm.

Facets 16 positioned at the edge of the component 10 can be formed by mechanical methods such as milling or laser cutting. U.S. patent application Ser. No. 09/690,959, filed on Oct. 16, 2000 and entitled “Formation of a Smooth Vertical Surface on an Optical Component” teaches a method of forming a facet 16 having a roughness greater than 20 nm. In some instances, this method provides a facet 16 roughness greater than 100 nm, 150 nm, 170 nm or 190 nm. Further, the facets 16 are often polished so as to have a roughness greater than 100 nm. Polishing techniques are difficult to apply to surfaces 12 that are not positioned at an edge of a component 10. Accordingly, polishing techniques are difficult to apply to the top and/or lateral sides 30 of the ridge 23 and are largely limited to polishing of facets 16 to the edge of the component 10.

The present method can be employed to smooth reflecting and/or transmitting surfaces 12. The method includes obtaining an optical component 10 having one or more surfaces 12 to be smoothed. Obtaining the component 10 can include fabricating the component 10 or receiving the component 10 from a supplier. The method also includes performing a smoothing etch so as to reduce the roughness of one or more surfaces 12 on the component 10.

A suitable smoothing etch includes applying a first medium and a second medium to the one or more surfaces 12. The first medium can be selected to convert the material that defines the one or more surfaces 12 to a second material. As shown above, the light transmitting medium 18 can be the material that defines the one or more surfaces 12. Conversion of the material to the second material can include changing the material, injecting a substance into the material and/or changing the structure of the material. An example of changing the structure of the material includes changing a crystalline structure of the material into another material. The second medium is selected to remove the second material from the one or more surfaces 12.

A suitable first medium can be an oxidant selected to convert the material that defines the one or more surfaces 12 to an oxide of the material that defines the one or more surfaces 12. In some instances, the first medium is selected to isotroptically convert the material that defines the one or more surfaces 12 to an oxide of the material that defines the one or more surfaces 12. Suitable first media include, but are not limited to, HNO₃, H₂O₂, and HF. The oxide of the material that defines the one or more surfaces 12 serves as the second material. A suitable second medium can be selected to remove the oxide from the one or more surfaces 12. Suitable oxide removers include, but are not limited to, HF and BOE (buffered oxide etch, HF with ammonium fluoride NH4F 1:6 or 1:10 standard pre-mix solution).

The smoothing etch can be a wet etch employing a solution that contains the first medium and the second medium. When the first medium is an oxidant and the second medium is an oxide remover, suitable molar ratios for the oxide remover to the oxidant include, but are not limited to, a range from 1:4 to 1:20, a range from 1:2 to 1:10, a range from 1:4 to 1:8 and a range from 1:5 to 1:7. Increasing the amount of oxidant increases the etch rate.

Suitable solvents or buffering agents include, but are not limited to, acetic acid (CH3COOH), and H₂O. The presence of water in the solution can reduce the oxidation power of the oxidant. Accordingly, the solvent can exclude water in some instances. For example, the solvent can be galacial acetic acid. Suitable molar ratios of oxidant to solvent include, but are not limited to, a range from 1:5 to 1:100, 1:20 to 1:80 and 1:30 to 1:50.

When the light transmitting medium 18 is silicon and the first medium is HNO₃, the HNO₃ reacts with the silicon to form SiO₂. When the second medium is HF, the HF reacts with the SiO₂ to form H₂SiF₆, which enters the solution and is accordingly removed from the component 10. When the solvent is acetic acid, the smoothing etch can be performed at room temperature and room pressure. As a result, there is no need for elevated temperatures and/or pressures. In some instances, the solution components are selected to provide an etching rate of about 20 nm/min.

The smoothing etch is performed until the desired level of smoothness is achieved. When the light transmitting medium 18 is silicon, the first medium is HN03, the second medium is HF and the solvent is acetic acid, the smoothing etch can generally provide smoothing of the optical component 10 to a smoothness of less than 5 nm in a period of 1 to 10 minutes depending on the initial roughness of the surface 12 to be smoothed.

After the smoothing etch, the component 10 can be cleaned with deionized water.

In some instances, the effect of the smoothing etch on the dimensions of the light transmitting medium 18 should be taken into consideration. For instance, when the smoothing etch is performed such that 0.02 μm of light transmitting medium 18 are removed and a ridge with a width of 7 μm is desired, the component 10 should be fabricated such that the ridge has a width of 7.04 μm before the smoothing etch is performed. The excess width of the ridge compensates for the effects of the smoothing etch.

When smoothing of one or more surfaces 12 on the optical component 10 is not desired, these surfaces 12 can be masked during the smoothing etch. When more than one surface 12 is to be smoothed, the level of smoothing desired on each of the surfaces 12 may be different. The smoothing etch is performed until each surface 12 has the desired level of smoothness. Alternatively, one surface 12 can be masked and a smoothing etch can be performed on the exposed surface(s) 12 until the level of smoothness desired for those surfaces 12 is achieved. The mask can be removed and another mask 40 formed so as to leave exposed regions of the component 10 where additional smoothing is desired. A second smoothing etch can then be performed to achieve the desired level of smoothness desired for the exposed surfaces 12. This technique can provide surfaces 12 having different degrees of smoothness.

The smoothing etch described above can result in surfaces 12 having a roughness of less than 1 nm depending on the duration and conditions of the smoothing etch as well as the material being etched. In some instances, the smoothing etch provide a surface 12 having a roughness less than 330 nm, less than 270 nm, less than 220 nm, less than 190 nm, less than 170 nm, less than 150 nm, 100 nm, less than 60 nm, less than 40 nm, less than 20 nm, less than 15 nm, less than 10 nm, less than 8 nm, less than 4 nm or less than 1 nm.

The method of the present invention can also include performing one or more foreign substance removal operations before performing the smoothing etch. The foreign substance removal operations remove foreign substances from the surface(s) to be smoothed by the smoothing etch. Foreign substances include substances other than the material that defines the surface 12. Many of these foreign substances can act like a mask during the smoothing etch. Because the portion of the light transmitting medium 18 under a foreign substance that acts as a mask are not smoothed, these foreign substances can cause the surface(s) to have an increased roughness. Removing these foreign substances before performing the smoothing etch prevents the foreign substances from increasing the surface roughness.

Examples of foreign substances include, but are not limited to, mask left on the surface 12 from incomplete mask removal, polymer formed on the surface 12 during the surface formation etch and air born contaminants such as are often found in clean rooms. Another example of a foreign substance includes a portion of the surface that has converted from the material that defines the surface to another material. For instance, the one or more surfaces 12 can be defined by silicon. Exposure of the component 10 to air can cause the silicon to convert to silica. When this silica is not desired on the surface 12, the silica can serve as a foreign substance that acts as a mask during the smoothing etch.

A suitable foreign substance removal operation includes an oxygen plasma cleaning. When a mask is constructed of photoresist, organic polymer or wax, the oxygen plasma cleaning can remove any mask left on the optical component 10. A suitable oxygen plasma cleaning step is performed with a 100% O2 plasma at 200 W of plasma power.

Another suitable foreign substance removal operation includes a polymer residue cleaning. A polymer residue cleaning can remove polymers formed during a surface formation etch. A suitable polymer residue cleaning operation includes a wet etch performed in a solution of H₂SO₄ and H₂O₂. When the solution has a H₂SO₄:H₂O₂ molar ratio of about 17:1, the wet etch can be performed for about 15 minutes at about 90° C. The wet etch can be followed by a deionized water rinse.

Another suitable foreign substance removal operation includes a silica removal operation for removing silica formed on a silicon. An example of a silica removal operation includes a wet etch in a 2% solution of HF or a standard BOE solution. Certain embodiments of the smoothing etch will remove silica. As a result, whether a silica removal operation is desired can depend on the conditions of the smoothing etch. Additionally, the silica removal operation is not needed when the component is fabricated such that silica does not form on the surfaces 12 to be smoothed. The silica removal operation can also be optional when the material that defines the one or more surfaces 12 is not subject to a tendency to convert to silica.

Although the component 10 and methods disclosed above are disclosed in conjunction with a ridge waveguide, the invention can be used with other types of optical components and other waveguide types. For instance, the invention can be used with components having channel waveguides. Additionally, the invention can be used to smooth surfaces 12 other than facets and sides of waveguides. For instance, the invention can be used to smooth the surfaces 12 of star couplers and Rowland circles.

The components disclosed above are typically used in the 1550 nm wavelength range although the method disclosed above can be employed with optical components using much different wavelength ranges.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method for smoothing one or more surfaces on an optical component, comprising:
obtaining an optical component having one or more surfaces; and
performing a wet etch so as to smooth the one or more surfaces.

2. The method of claim 1, wherein the one or more surfaces are formed in a light transmitting medium positioned adjacent to a substrate.

3. The method of claim 1, wherein performing the smoothing etch includes concurrently applying an oxidant and an oxide remover to the component.

4. The method of claim 3, wherein the oxidant is HNO₃ and the oxide remover is HF.

5. The method of claim 3, wherein a molar ratio of oxidant to oxide remover is within a range of 1:1 to 1:20.

6. The method of claim 3, wherein a molar ratio of oxidant to oxide remover is within a range of 1:4 to 1:8.

7. The method of claim 3, wherein the oxidant and the oxide remover are included in solution having a solvent that excludes water.

8. The method of claim 7, wherein the solvent includes acetic acid.

9. The method of claim 1, further comprising:
performing one or more foreign substance removal operations before performing the smoothing etch, the foreign substance removal operations being configured to remove foreign substances from the one or more surfaces to be smoothed by the smoothing etch.

10. The method of claim 9, herein the one or more foreign substance removal operations includes at least one operation selected from a group consisting of an oxygen plasma clean, a polymer residue clean and a silica removal.

11. The method of claim 1, wherein obtaining an optical component having one or more surfaces includes receiving the optical component from a supplier.

12. The method of claim 1, wherein obtaining an optical component having one or more surfaces includes performing a surface formation etch so as to form the one or more surfaces.

13. The method of claim 12 wherein the one or more surfaces includes at least one surface selected from a group consisting of a surface through which light signals are transmitted and a surface at which light signals are reflected.

14. The method of claim 1, wherein the one or more rough surfaces have a roughness of greater than 220 nm before the smoothing etch and performing the smoothing etch provides the one or more surfaces with a smoothness less than 220 nm.

15. The method of claim 1, wherein the one or more rough surfaces have a roughness of greater than 150 nm before performing the smoothing etch and performing the smoothing etch provides the one or more surfaces with a smoothness less than 50 nm.

16. A method for smoothing a surface on an optical component, comprising:
obtaining an optical component having a material defining one or more surfaces;
applying an oxidant to the one or more surfaces such that an oxide of the material is formed on the one or more surfaces; and
applying an oxide remover to the one or more surfaces so as to remove the oxide from the one or more surfaces, the oxide remover being applied to the one or more surfaces concurrently with the oxidant.

17. The method of claim 16, wherein the one or more surfaces includes at least one surface selected from a group consisting of a surface through which light signals are transmitted and a surface at which light signals are reflected.

18. The method of claim 16, wherein the oxidant and the oxide remover are applied in a wet etch.

19. The method of claim 16, wherein the oxidant includes HNO₃ and the oxide remover includes HF.

20. The method of claim 16, wherein the oxidant and oxide remover are applied at a molar ratio of oxidant to oxide remover within a range of 1:1 to 1:20.

21. The method of claim 16, wherein the oxidant and oxide remover are applied at a molar ratio of oxidant to oxide remover within a range of 1:4 to 1:8.

22. The method of claim 16, wherein the oxidant and the oxide remover are applied in a solution that excludes water.

23. The method of claim 22, wherein the solution includes acetic acid as a solvent.

24. The method of claim 16, further comprising:
performing one or more foreign substance removal operations before applying the oxidant, the foreign substance removal operations being configured to remove foreign substances from the one or more surfaces to be smoothed.

25. The method of claim 16, wherein obtaining an optical component having one or more surfaces includes performing a surface formation etch so as to form the one or more surfaces.

26. The method of claim 16, wherein the oxidant is applied to the one or more surfaces such that the oxide is isotropically formed.

27. A method for smoothing one or more surfaces on an optical component, comprising:
applying a first medium to the one or more surfaces of the optical component so as to converting a material that defines the one or more surfaces of the optical component to a second material; and
applying a second medium to the one or more surfaces of the optical component so as to removing at least a portion of the second material from the one or more surfaces of the optical component, the second medium being applied concurrently with the first medium.

28. The method of claim 27, wherein the first medium is an oxidant that oxidizes the first material.

29. The method of claim 28, wherein the oxidant is HNO₃.

30. The method of claim 27, wherein second medium includes HF.

31. The method of claim 27, wherein the first medium and the second medium are applied to the one or more surfaces in a wet etch solution.

32. The method of claim 26, wherein the first medium is applied to the one or more surfaces of the optical component so as to isotropically convert the material that defines the one or more surfaces of the optical component to the second material.
